(19) United States
(12) Patent Application Publication
(10) Pub. No.: US 2005/0276207 A1
(43) Pub. Date: Dec. 15, 2005

(54) Objective lens, actuator, optical head, and optical recording/reproducing apparatus

(75) Inventors: Teiichiro Oka, Tokyo (JP); Sho Nakagomi, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/144,592

(22) Filed: Jun. 6, 2005

(30) Foreign Application Priority Data
Jun. 15, 2004 (JP) 2004-176585

(51) Int. Cl. G11B 7/00; G11B 7/135

(52) U.S. Cl. 369/112.23; 369/44.23; 369/112.01

(57) ABSTRACT

The invention relates to an objective lens for converging light emitted by a light source to irradiate an optical recording medium with the convergent light, an actuator having the same, an optical head for recording information on the optical recording medium and reproducing information recorded on the same, and an information recording/reproducing apparatus utilizing the same. The invention provides an objective lens whose lens protecting section can be prevented from being coming off due to collision. The invention also provides an actuator, an optical head, and an optical recording/reproducing apparatus having the objective lens whose lens protecting section can be prevented from being coming off due to collision. An objective lens has a lens section and a lens peripheral section formed around the lens section integrally with the same. The lens peripheral section includes a separation preventing section which is formed in a region where a lens protecting section is secured and which prevents the lens protecting section from being separated from the lens peripheral section at the time of collision with an optical recording medium.

### BACKGROUND OF THE INVENTION

1. Field of the Invention

The present invention relates to an objective lens for converging light emitted from a light source to irradiate an optical recording medium with the convergent light, an actuator having the objective lens, an optical head for recording information on the optical recording medium or reproducing information recorded on the same, and an optical recording/reproducing apparatus utilizing them.

2. Description of the Related Art

An optical recording/reproducing apparatus has a spindle motor for rotating an optical recording medium and an optical head for recording information on the optical recording medium or reproducing information from the medium. An optical recording/reproducing apparatus also has a signal calculation unit for performing calculation and amplification of an electrical signal which has been photo-electrically converted by the optical head and a controller for performing various types of signal processing and controlling operations of the optical head and the spindle motor. Further, an optical recording/reproducing apparatus has a laser driving circuit for supplying a laser driving signal to the optical head and an actuator driving circuit for supplying an actuator driving signal to the optical head. The laser driving circuit is frequently mounted on the optical head.

Recently, there are demands for optical recording devices having a large capacity, and a known method for increasing the recording capacity of an optical recording medium is to increase the numerical aperture (NA) of the objective lens used. Use is made of the inverse proportionality of the diameter of a beam spot to the numerical aperture of the objective lens. That is, the diameter of a beam spot is made smaller by incleasing the numerical aperture of the objective lens to allow smaller marks to be recorded and reproduced. Thus, the recording capacity of an optical recording medium can be increased. Since the numerical aperture of a lens is inversely proportionate to the focal length of the lens, the distance between an objective lens and an optical recording medium (working distance) is short when the objective lens used has a great numerical aperture.

When an optical recording/reproducing apparatus is subjected to an accidental shock during recording or reproduction, the objective lens and the optical recording medium can collide with each other, and the objective lens and the optical recording medium can be damaged. For this reason, a lens protecting section is provided around a movable part of the actuator or the objective lens such that it protrudes toward the optical recording medium from the objective lens. The lens protecting section contacts the optical recording medium before the objective lens contacts the same, which makes it possible to prevent collision between the objective lens and the optical recording medium. The frequency or possibility of contact between the lens protecting section and the optical recording medium becomes higher, the shorter the working distance.

When an optical recording device has comatic aberration attributable to an angular misalignment (tilt) between the optical recording medium and the optical axis of the objective lens, the quality of a beam spot will be degraded. Therefore, tilt adjustment must be performed when an optical head is assembled. Since an objective lens with a great numerical aperture has a short working distance, when a lens protecting section is provided in a location of a movable part of an actuator apart from the objective lens, e.g., at a lens holder, a slight tilt of the actuator increases the possibility of the collision of the lens protecting section with the optical recording medium. Further, when an optical system of an optical head including an objective lens has comatic aberration of itself, the actuator must be intentionally tilted to cancel the aberration with comatic aberration in the opposite direction. Therefore, when the comatic aberration of the optical head itself is great and, in addition, when members such as the lens protecting section are mounted and shaped with low accuracy, the lens protecting section and an optical recording medium can contact each other during tilt adjustment to disable the adjustment.

Therefore, in an objective lens having a lens section for converging light emitted by a light source to irradiate an optical recording medium with the convergent light and a lens peripheral section formed around the lens section integrally with the same, a lens protecting section is provided in a location close to the lens section, e.g., on the lens peripheral section. As a method involving a lens protecting section provided on a peripheral section of an objective lens, Patent Document 1 discloses a method in which a buffering section on an end of a flange which is formed around an optical functional section of an objective lens integrally with the same. Patent Document 2 discloses a method in which a protective material is provided on a peripheral surface of the body of an objective lens such that the material protrudes above a protruding surface of the lens body.
Patent Document 1: JP-A-2003-217163
Patent Document 2: JP-A-2000-242958

As disclosed in Patent Documents 1 and 2, tilt adjustment can be performed with a great margin of adjustment when a buffering section or protective material is provided on a lens peripheral section of an objective lens. However, a buffering section or protective material has low adhesion because it is formed by applying a resin or rubber to a flat peripheral section of an objective lens. A problem therefore arises in that a lens protecting section is highly likely to come off due to the shock of a collision between the objective lens and an optical recording medium.

### SUMMARY OF THE INVENTION

It is an object of the invention to provide an objective lens whose lens protecting section can be prevented from being separated due to a collision. It is another object of the invention to provide an actuator, an optical head, and an optical recording/reproducing apparatus having the objective lens whose lens protecting section can be prevented from being separated.

The above-described objects are achieved by an objective lens characterized in that it has a lens section for converging light emitted by a light source to irradiate a recording medium with the convergent light; a lens peripheral section formed around the lens section integrally with the lens section and securing a lens protecting section which protects the lens section at the time of a collision with the recording medium; and a separation preventing section formed in a region of the lens peripheral section where the lens protecting section is secured and preventing the lens protecting section from being separated from the lens peripheral section at the time of the collision.

The invention provides an objective lens according to the above invention, characterized in that a surface of the separation preventing section is formed with roughness higher than that of a surface of the lens section.

The invention provides an objective lens according to the above invention, characterized in that the separation preventing section is formed like a groove.

The invention provides an objective lens according to the above invention, characterized in that the separation preventing section is formed like a protrusion.

The invention provides an objective lens according to the above invention, characterized in that the separation preventing section is formed in two or more (a plurality of) locations.

The invention provides an objective lens according to the above invention, characterized in that the separation preventing section is formed like a ring extending in the circumferential direction of the lens peripheral section when viewed in the direction of the optical axis of the lens section.

The invention provides an objective lens according to the above invention, characterized in that the lens protecting section is formed of an elastic material having hardness lower than that of the recording medium.

The invention provides an objective lens according to the above invention, characterized in that the lens protecting section includes a resin having adhesive properties formed on the separation preventing section.

The invention provides an objective lens according to the above invention, characterized in that the lens section and the lens peripheral section are formed of a plastic material.

The invention provides an objective lens according to the above invention, characterized in that the lens section and the lens peripheral section are formed of a glass material.

The above-described objects are also achieved by an actuator characterized in that it includes an objective lens according to the above invention.

The above-described objects are also achieved by an optical head characterized in that it includes an actuator according to the above invention.

The above-described objects are also achieved by an optical recording/reproducing apparatus characterized in that it includes an optical head according to the above invention.

The invention makes it possible to prevent a lens protecting section from being separated from a lens peripheral section at the time of collision.

### BRIEF DESCRIPTION OF THE DRAWINGS

FIG. 1 shows a schematic configuration of an optical head 1 according to an embodiment of the invention;

FIGS. 2A, 2B, and 2C show an objective lens 9 according to the embodiment of the invention;

FIG. 3 shows the objective lens 9 according to the embodiment of the invention;

FIG. 4 shows a first modification of the objective lens 9 according to the embodiment of the invention;

FIGS. 5A, 5B, and 5C show the first modification of the objective lens 9 according to the embodiment of the invention;

FIGS. 6A and 6B show a second modification of the objective lens 9 according to the embodiment of the invention;

FIG. 7 shows another example of the second modification of the objective lens 9 according to the embodiment of the invention;

FIG. 8 shows a third modification of the objective lens 9 according to the embodiment of the invention;

FIG. 9 shows a fourth modification of the objective lens 9 according to the embodiment of the invention;

FIGS. 10A and 10B show a fifth modification of the objective lens 9 according to the embodiment of the invention;

FIG. 11 shows another example of the fifth modification of the objective lens 9 according to the embodiment of the invention;

FIGS. 12A and 12B show a sixth modification of the objective lens 9 according to the embodiment of the invention;

FIG. 13 shows a seventh modification of the objective lens 9 according to the embodiment of the invention; and

FIG. 14 shows a configuration of an optical recording/reproducing apparatus according to the embodiment of the invention.

### DETAILED DESCRIPTION OF THE PREFERRED EMBODIMENT

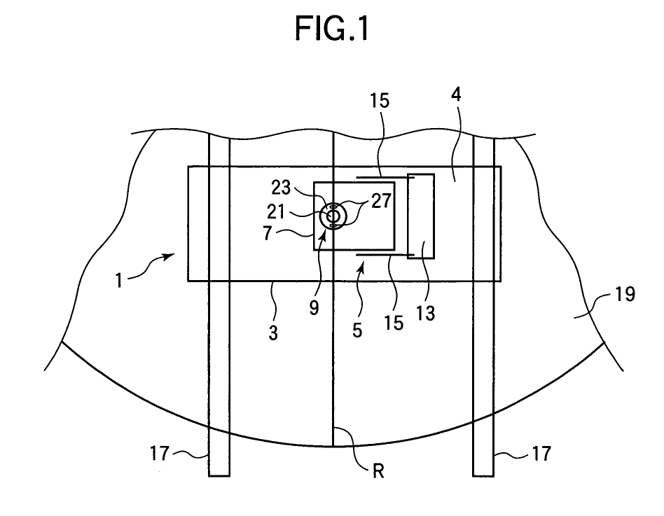

A description will now be made with reference to FIGS. 1 to 14 on an objective lens, an actuator, an optical head, and an optical recording/reproducing apparatus according to an embodiment of the invention. First, a schematic configuration of an optical head 1 according to the present embodiment will be described with reference to FIG. 1. Referring to FIG. 1, the optical head 1 can be driven by a coarse motor, which is not shown, for movements in the radial direction R of an optical recording medium 19 under guidance provided by, for example, two guides 17 extending in parallel with the radial direction R of the medium. An actuator 5 is made movable by combining it with a magnet which is not shown and a focusing coil and a tracking coil provided on a surface opposite to the magnet.

A lens holder 7 is supported by, for example, four conductive elastic bodies 15 extending from a wire base 13 erected on a base plate section 4 of a housing 3 of the optical head 1. The conductive elastic bodies 15 serve as a wiring for energizing a coil in the lens holder 7 and also have the function of cantilevering the lens holder 7 such that the holder can be moved relative to the wire base 13.

An objective lens 9 includes a lens section 21 and a lens peripheral section 23 formed around the lens section 21 integrally with the same. Two lens protecting sections 27 are provided at the lens peripheral section 23 to prevent collision between the lens section 21 and an optical recording medium 19. The lens protecting sections 27 are formed on the lens peripheral section 23 such that they face each other with the lens section interposed between them. The two lens protecting sections 27 are located in respective positions in the radial direction R of the optical recording medium 19 so as to sandwich the optical axis of the objective lens 9. Further, the objective lens 9 is secured in the lens holder 7. The objective lens 9 is positioned such that it will be moved in the radial direction R of the optical recording medium 19, i.e., on a straight line extending through the center of rotation of the optical recording medium 19 or in a direction orthogonal to a line tangential to a recording track of the medium during a seek operation of the optical head 1.

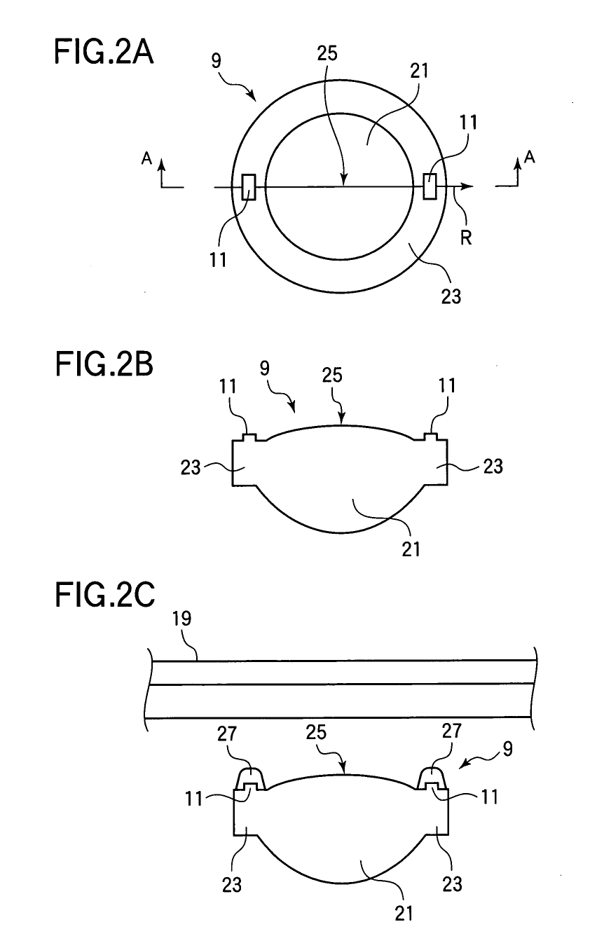

FIGS. 2A, 2B, and 2C show the objective lens 9 according to the present embodiment. FIG. 2A is a view of the objective lens 9 taken in the direction of the optical axis of the objective lens 9 from the side of a surface of the lens facing the medium. FIG. 2B is a sectional view of the lens taken along an imaginary line A-A extending through the optical axis in FIG. 2A. FIG. 2C shows a state of the objective lens 9 in which the lens protecting sections 27 are secured at the lens peripheral section 23. As shown in FIGS. 2A and 2B, the objective lens 9 has the lens section 21 whose light entering/exiting surface is formed like a convex curved surface to irradiate the optical recording medium 19 with convergent light by converging light emitted by the light source. The lens peripheral section 23, which is ring-shaped, is formed around the lens section 21. The objective lens 9 is formed of a plastic material, and the lens section 21 and the lens peripheral section 23 are formed integrally with each other.

In the regions on the side of the lens peripheral section 23 facing the optical recording medium 19 (hereinafter referred to as “the surface of the lens peripheral section 23”) where the lens protecting sections 27 are secured, separation preventing sections 11 are formed to prevent the lens protecting sections 27 from being separated from the lens peripheral section 23 at the time of collision. Two separation preventing sections 11 are formed on the surface of the lens peripheral section 23 such that they are substantially symmetric about the optical axis of the lens section 21. The separation preventing sections 11 are formed like rectangular convex protrusions and are formed at the same time when the objective lens 11 is molded.

As shown in FIG. 2C, the lens protecting sections 27 provided to prevent the lens section 21 from colliding with the optical recording medium 19 are secured on the separation preventing sections 11. For example, the lens protecting sections 27 are formed in a rectangular parallelepiped configuration from a material lower in hardness than the optical recording medium 19 such as an ultraviolet-setting, thermosetting, or deoxime type resin. The lens protecting sections 27 are formed higher than a peak of protrusion 25 of the spherical surface of the lens section 21 in the sectional view. Since the lens section 21 is thus prevented from colliding with the optical recording medium 19, any damage on the lens section 21 or the optical recording medium 19 can be prevented.

When the lens protecting sections 27 are secured on the separation preventing sections 11, the separation preventing sections 11 are covered by the lens protecting sections 27, and the separation preventing sections 11 partially protrude into the lens protecting sections 27. Since this allows adhesion between the lens protecting sections 27 and the objective lens 9 to be improved, even if the lens protecting sections 27 and the optical recording medium 19 collide with each other when the head is driven to make the objective lens 9 and the optical recording medium 19 closer to each other, it is possible to reliably prevent the lens protecting sections 27 from being separated from the lens peripheral section 23 by a resultant shock. Further, the adjustment of the height of the lens protecting sections 27 is facilitated by forming the separation preventing sections 11 so as to protrude into the same.

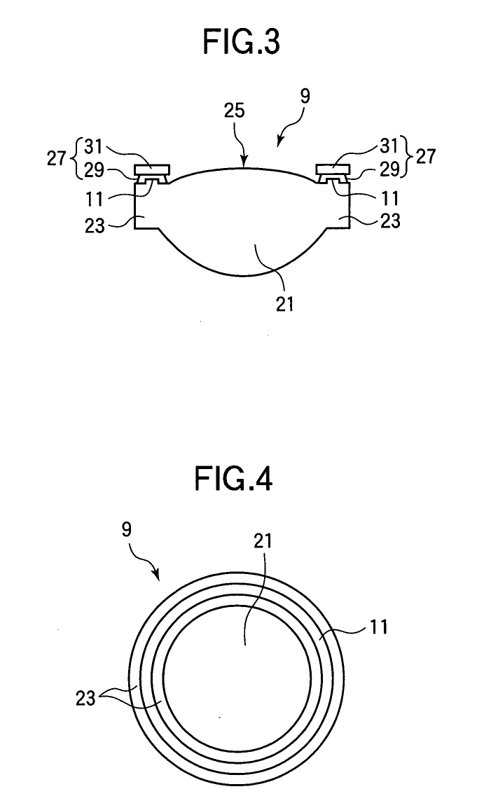

As shown in FIG. 3, the lens protecting sections 27 may include bonding parts 29 which are formed on the separation preventing sections 11 from a resin having adhesive properties and protective pads 31 which are secured to the bonding parts 29. For example, the protective pads 31 are formed from a material lower in hardness than the optical recording medium 19 such as rubber, silicone rubber, thermoplastic elastomer, Teflon (registered trademark), or the like. The bonding parts 29 are formed from an ultraviolet-setting resin, thermosetting resin, deoxime type resin, or the like. The same advantage as that of the embodiment can be achieved by forming the lens protecting sections 27 such that the protective pads 31 become higher than the peak of protrusion 25 of the lens section 21 in the sectional view.

As described above, according to the present embodiment, the separation preventing sections 11 formed like protrusions are provided on the surface of the lens peripheral section 23 of the objective lens 9, and the lens protecting sections 27 are secured on the same, which allows adhesion between the surface of the lens peripheral section 23 and the lens protecting sections 27 to be improved. As a result, the lens protecting sections 27 will not come off the surface of the lens peripheral section 23 even when they collide with the optical recording medium 19. Further, since the lens section 21 and the lens protecting sections 27 can be made close to each other, a great margin is made available for tilt adjustment at the time of assembly of the optical head, and the tilt adjustment can therefore be performed without any problem even when the objective lens 9 has a great numerical aperture and a short working distance.

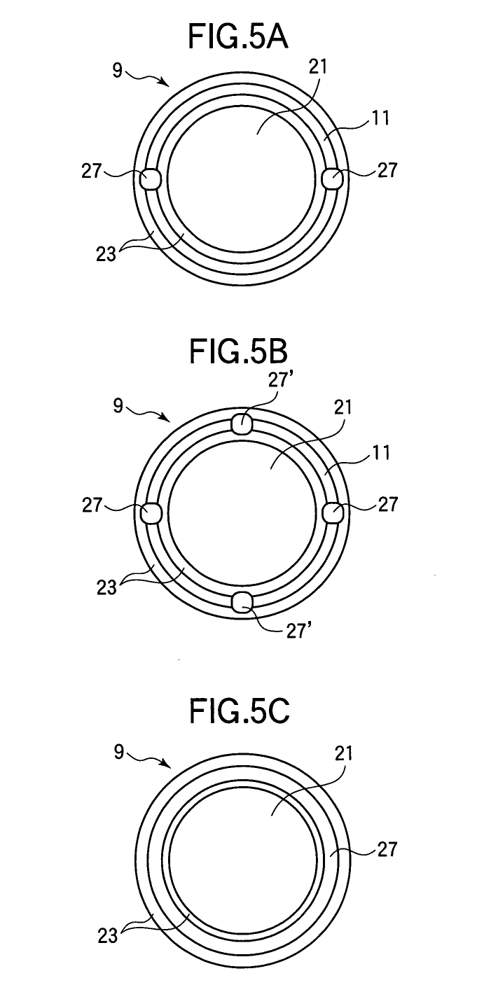

A first modification of the embodiment will now be described with reference to FIGS. 4 to 5C. FIG. 4 is a view of an objective lens 9 taken in the direction of the optical axis of the same from the side of the lens surface facing an optical recording medium 19. FIGS. 5A, 5B, and 5C show a state of the lens in which lens protecting sections 27 are secured on a lens peripheral section 23. As shown in FIG. 4, the objective lens 9 in the present modification is characterized in that it has a separation preventing section 11 formed like an annular protrusion extending in the circumferential direction of the surface of the lens peripheral section 23. Since the separation preventing section 11 is provided in the form of a ring extending in the circumferential direction of the surface of the lens peripheral section 23, the positions to secure the lens protecting sections 27 can be arbitrarily chosen. Therefore, a disposing direction for the objective lens 9 (direction/azimuth of rotation of the objective lens 9 about the optical axis thereof) can be freely chosen when the objective lens 9 is mounted in a lens holder 7. Thus, the optical head 1 can be assembled according to a method which is adopted when it is desirable to use the astigmatism of the objective lens 9 to cancel any astigmatism of the optical system ranging from the light source up to the objective lens 9 excluding the astigmatism of the objective lens 9. In this case, the lens protecting sections 27 are mounted after the objective lens 9 is bonded to the lens holder 7.

For example, after the objective lens 9 is secured in the lens holder 7 so as to cancel any astigmatism of the optical system with the astigmatism of the objective lens 9, as shown in FIG. 5A, two lens protecting sections 27 formed of a resin may be mounted on the surface of the lens peripheral section 23 such that they sandwich the optical axis of the objective lens 9 in the radial direction R of the optical recording medium 19. As shown in FIG. 5B, in addition to the lens protecting sections 27 in the radial direction (in the lateral direction of the figure), two further lens protecting sections 27′ formed of a resin may be mounted on the surface of the lens peripheral section 23 such that they sandwich the optical axis of the objective lens 9 in a direction that is orthogonal to the radial direction and tangential to a recording track of the optical recording medium 19 (tangential direction). This arrangement is advantageous when the actuator 5 tends to tilt in the tangential direction after the tilt adjustment.

Further, as shown in FIG. 5C, an annular lens protective section 27 formed of a resin may be mounted on the surface of the lens peripheral section 23 so as to cover the separation preventing section 11 as a whole. In this case, a disposing direction of the objective lens 9 in the lens holder 7 can be freely chosen even when the lens protecting section 27 is provided on the objective lens 9 before bonding the objective lens 9 to the lens holder 7. Therefore, the lens protecting section 27 may be provided on the objective lens 9 when it stands alone. Thus, an operation of mounting the lens protecting section 27 can be included in a step for manufacturing the objective lens 9 to improve the mass-productivity of the optical head 1.

The present modification is the same as the above-described embodiment in that the separation preventing section 11 is covered by the lens protecting section 27 and the separation preventing section 11 partially protrudes into the lens protecting section 27 when the lens protecting section 27 is secured on the separation preventing section 11, and the same advantage as that of the above-described embodiment can be achieved.

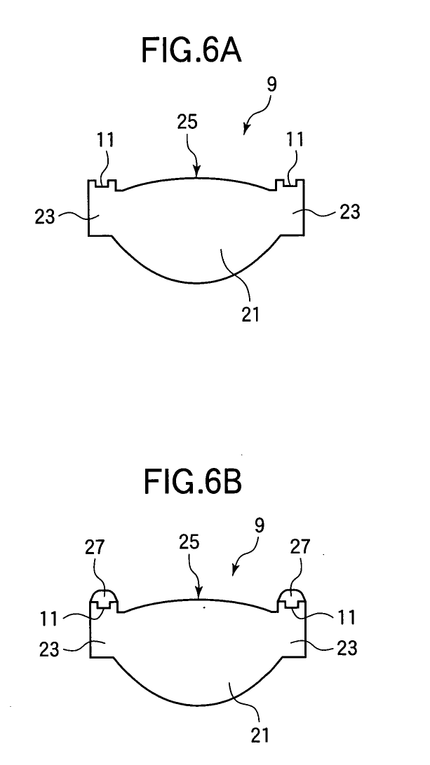

A second modification of the embodiment will now be described with reference to FIGS. 6A and 6B. FIGS. 6A and 6B show a section of an objective lens 9 taken in parallel with the optical axis of the same. FIG. 6A is a sectional view of the objective lens 9, and FIG. 6B shows a state of the objective lens 9 in which lens protecting sections 27 are secured on a lens peripheral section 23 of the objective lens 9. As shown in FIG. 6A, the objective lens 9 of the present modification is characterized in that the regions on the surface of the lens peripheral section 23 where the lens protecting sections 27 are secured are formed with a height that is substantially the same as the height of a peak of protrusion 25 of the lens. The modification is further characterized in that two separation preventing sections 11 like grooves in the form of rectangular parallelepiped recesses are formed on the surface of the lens peripheral section 23 such that they are substantially symmetric about the optical axis of a lens section 21.

In the case of an objective lens 9 formed of a plastic material, for purposes such as prevention of polarization of a density distribution at the time of manufacture, a large lens peripheral section 23 is provided. As a result, the regions on the surface of the lens peripheral section 23 where the lens protecting sections 27 are secured may be formed with a height that is substantially the same as the height of the peak of protrusion 25 of the lens section 21. In such a case, if the separation preventing sections 11 are in the form of protrusions, the separation preventing sections 11 alone become higher than the peak of protrusion 25 of the lens section 21. When the lens protecting sections 27 are further provided on the separation preventing sections 11, the working distance of the lens is significantly reduced as a consequence, and there will be an increased possibility of frequent collisions of the lens with an optical recording medium 19. For this reason, the separation preventing sections 11 are preferably in the form of grooves in the present modification, but it is obvious that separation preventing sections 11 in the form of protrusions may alternatively be employed.

When the lens protecting sections 27 are secured on the surface of the lens peripheral section 23 as shown in FIG. 6B, the lens protecting sections 27 are formed so as to cover the separation preventing sections 11 from above and are formed with a part of the same embedded in the separation preventing sections 11. Since this allows adhesion between the lens protecting sections 27 and the objective lens 9 to be improved, the same advantage as that of the above-described embodiment can be achieved.

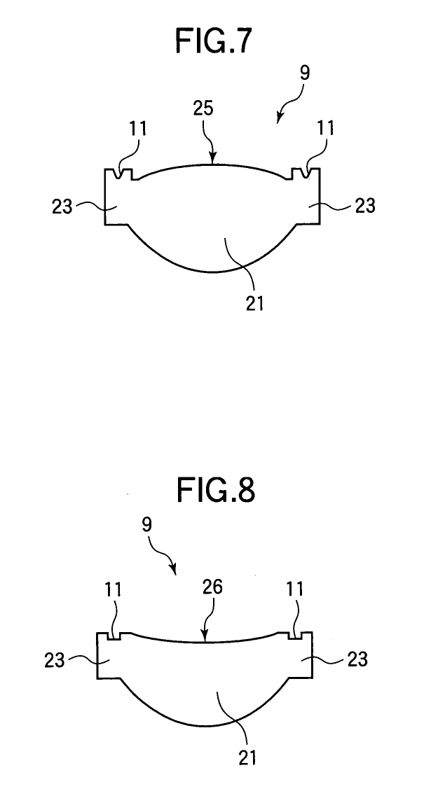

The shape of the separation preventing sections 11 is not limited to the groove-like configuration in the form of a rectangular parallelepiped recess, and the same advantage as that of the above-described embodiment can be achieved by forming the sections in the form of recesses having a triangular sectional shape as shown in FIG. 7. Alternatively, the separation preventing section 11 may be formed in the form of an annular recess extending in the circumferential direction of the surface of the lens peripheral section 23. Since four lens protecting sections 27 or an annular lens protecting section 27 can be thus secured to the surface of the lens peripheral section 23 as shown in FIGS. 5B and 5C, the same advantage as that of the first modification can be achieved.

A third modification of the embodiment will now be described with reference to FIG. 8. FIG. 8 is a sectional view of an objective lens 9 taken in parallel with the optical axis of the same. As shown in FIG. 8, the present modification is characterized in that a surface of a lens section 21 of the objective lens 9 in the present modification facing an optical recording medium 19 is a concave spherical surface and in that the surface of the lens peripheral section 23 is formed in a position higher than an apex 26 of the recess. Therefore, the present modification is similar to the second modification in that the separation preventing sections 11 preferably have a groove-like shape in order to prevent frequent collisions with the optical recording medium 19 and to prevent significant reduction in the working distance. However, it is obvious that separation preventing sections 11 in the form of protrusions may alternatively be used.

Two separation preventing sections 11 may be formed on the surface of the lens peripheral section 23 such that they are substantially symmetric about the optical axis of the lens section 21. It is obvious that a separation preventing section may be formed like an annular recess in the circumferential direction of the surface of the lens peripheral section 23. The lens protecting sections 27 in the present modification also cover the separation preventing sections 11 when they are secured to the surface of the lens peripheral section 23, and the protecting sections are formed with a part of the same embedded in the separation preventing sections 11. Since this allows adhesion between the lens protecting sections 27 and the objective lens 9 to be improved, the same advantage as that in the above-described embodiment can be achieved.

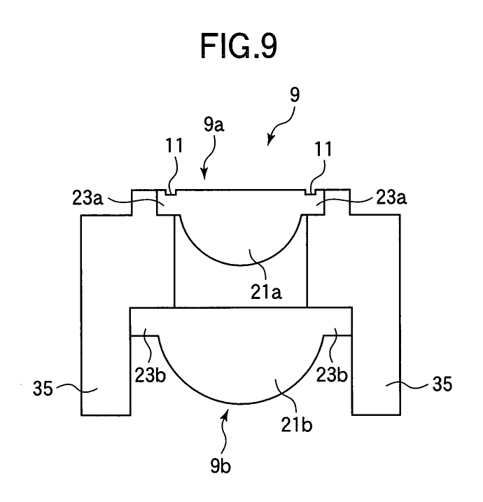

A fourth modification of the embodiment will now be described with reference to FIG. 9. FIG. 9 is a sectional view of an objective lens 9 taken in parallel with the optical axis thereof. As shown in FIG. 9, the objective lens 9 of the present modification has a front lens 9a and a rear lens 9b to provide a great numerical aperture. The front lens 9a includes a lens section 21a and a lens peripheral section 23a formed around the lens section 21a integrally with the same. Similarly, the rear lens 9b includes a lens section 21b and a lens peripheral section 23b formed around the lens section 21b integrally with the same.

The front lens 9a is secured to a cylindrical lens holder 35 by bonding the lens peripheral section 23a to the region of an end face of the holder such that the lens faces an optical recording medium 19. The rear lens 9b is secured to the lens holder 35 by bonding the lens peripheral section 23b to an inner part of the holder, the rear lens 9b being provided at a predetermined interval from the front lens 9a. Since the surface of the lens peripheral section 23a of the front lens 9a and the surface of the lens section 21a facing the optical recording medium 19 are formed at substantially the same height as shown in FIG. 9, the separation preventing sections 11 are preferably in the form of grooves such that there will be no significant reduction in the working distance and no frequent collisions with the optical recording medium 19. It is however obvious that separation preventing sections 11 in the form of protrusions may alternatively be employed. Even though the objective lens 9 includes the two lenses 9a and 9b, the same advantage as that of the above-described embodiment can be achieved by forming the separation preventing sections 11 on the surface of the lens peripheral section 23a of the front lens 9a facing the optical recording medium 19 to secure the lens protecting sections 27.

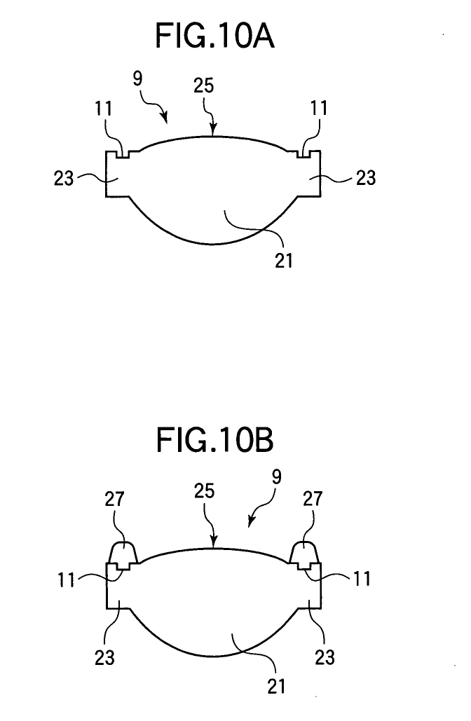

A fifth modification of the embodiment will now be described with reference to FIGS. 10A and 10B. FIGS. 10A and 10B are sectional views of an objective lens 9 taken in parallel with the optical axis thereof. FIG. 10A shows a section of the objective lens 9, and FIG. 10B shows a state of the objective lens 9 in which lens protecting sections 27 are secured to a lens peripheral section 23. As shown in FIG. 10A, the objective lens 9 of the present modification is characterized in that the regions on the surface of the lens peripheral section 23 where the lens protecting sections 27 are secured are formed with a height smaller than the height of a peak of protrusion 25 of the lens. The lens is further characterized in that two separation preventing sections 11 formed like grooves in the form of rectangle parallelepiped recesses are formed on the surface of the lens peripheral section 23 such that they are substantially symmetric about the optical axis of the lens section 21.

As shown in FIG. 10B, even though the height of the regions on the surface of the lens peripheral section 23 where the lens protecting sections 27 are secured is smaller than the height of the peak of protrusion 25, the lens section 21 can be prevented from colliding with the optical recording medium 19 by forming the lens protecting sections 27 higher than the peak of protrusion 25. Thus, damage on the lens section 21 or optical recording medium 19 can be prevented. When the lens protecting sections 27 are secured on the surface of the lens peripheral section 23, the lens protecting sections 27 covers the separation preventing sections 11 from above, and the sections 27 are formed with a part of the same embedded in the separation preventing sections 11. Since adhesion between the lens protecting sections 27 and the objective lens 9 can be thus improved, the same advantage as that of the above-described embodiment can be achieved.

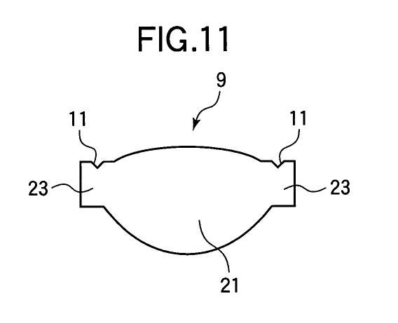

The shape of the separation preventing sections 11 is not limited to the groove-like configuration in the form of a rectangular parallelepiped recess, and the same advantage as that of the present modification can be achieved by forming the sections in the form of recesses having a triangular sectional shape as shown in FIG. 11. Alternatively, the separation preventing section 11 may be formed in the form of an annular recess extending in the circumferential direction of the surface of the lens peripheral section 23. In this case, the same advantage as that of the first modification can be achieved.

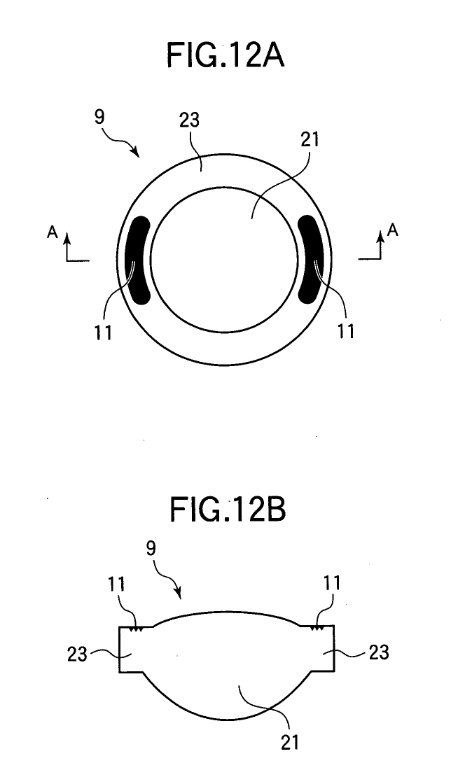

A sixth modification of the embodiment will now be described with reference to FIGS. 12A and 12B. FIG. 12A is a view of an objective lens 9 taken in the direction of the optical axis thereof from the side of the surface of the lens facing an optical recording medium 19. FIG. 12B is a sectional view taken along the imaginary line A-A passing through the optical axis in FIG. 12A. As shown in FIGS. 12A and 12B, the objective lens 9 of the present modification is characterized in that it has separation preventing sections 11 having a surface formed with roughness higher than that of a lens section 21. The separation preventing sections 11 are formed with a satin-like surface and a sawtooth-like sectional shape. For example, the satin-like surface is formed with roughness of 25-S (according to JISB0659). For example, separation preventing sections 11 are formed in an elliptic shape as viewed in the optical axis and are curved in the form of a fan.

Lens protecting sections 27 are formed so as to cover the separation preventing sections 11, and the lens protecting sections 27 are therefore formed with a part thereof embedded in recesses of the satin-like surface. Thus, adhesion between the lens protecting sections 27 and the objective lens 9 is improved, and the same advantage as that of the above-described embodiment can be achieved.

When the objective lens 9 is formed from a glass material, it is difficult to form the separation preventing sections 11 like grooves or protrusions than when forming them from a plastic material. It is therefore more advantageous to use the separation preventing sections 11 formed with a satin-like surface for an objective lens 9 made of a glass material. Further, since the separation preventing sections 11 have a satin-like surface, a high interfacial energy is generated at the contact surface between the resin from which the lens protecting sections 27 are formed and the separation preventing sections 11, which makes it easier to maintain the lens protecting sections 27 in a predetermined shape.

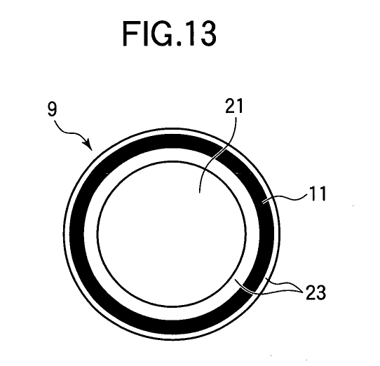

A seventh modification of the embodiment will now be described with reference to FIG. 13. FIG. 13 shows an objective lens 9 as viewed in the direction of the optical axis thereof from the side of the surface of the lens facing an optical recording medium 19. As shown in FIG. 13, the objective lens 9 of the present modification is characterized in that it has a separation preventing section 11 which is a satin-like surface formed like a ring extending in the circumferential direction of a surface of a lens peripheral section 23. Since four lens protecting sections 27 or an annular lens protecting section 27 can be secured to the surface of the lens peripheral section 23 as shown in FIGS. 5B and 5C, the same advantage as that of the first modification can be achieved.

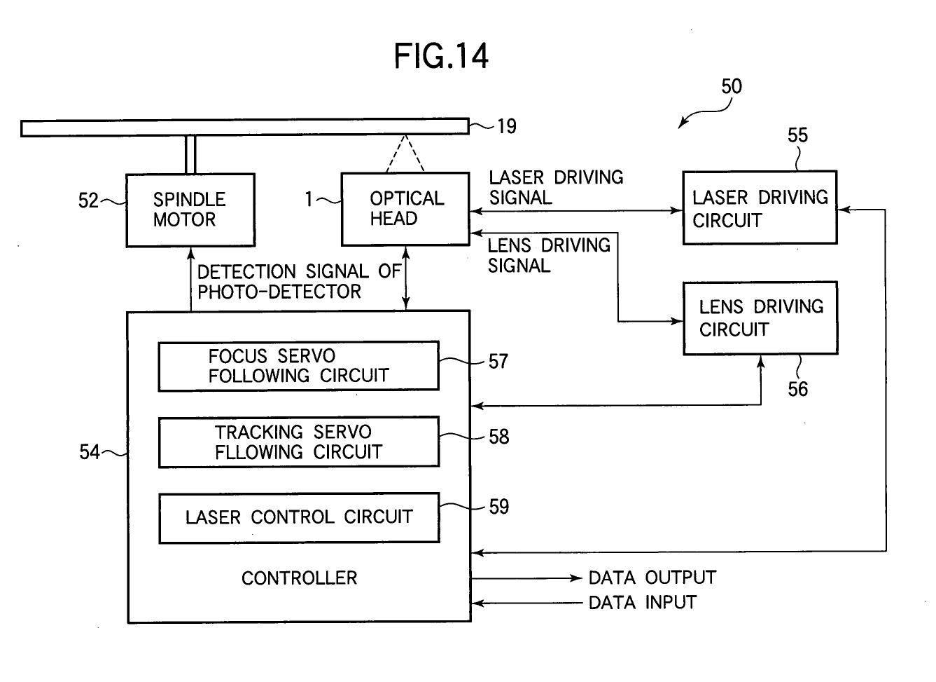

FIG. 14 shows a schematic configuration of an optical recording/reproducing apparatus 50 loaded with an optical head 1 according to the present embodiment. As shown in FIG. 14, the optical recording/reproducing apparatus 50 has a spindle motor 52 for rotating an optical recording medium 19, an optical head 1 for irradiating the optical recording medium 19 with a laser beam and for receiving reflected light from the same, a controller 54 for controlling the operation of the spindle motor 52 and the optical head 1, a laser driving circuit 55 for supplying a laser driving signal to the optical head 1, and a lens driving circuit 56 for supplying a lens driving signal to the optical head 1.

The controller 54 includes a focus servo following circuit 57, a tracking servo following circuit 58, and a laser control circuit 59. When the focus servo following circuit 57 is activated, an information recording surface of the optical recording medium 19 that is rotating is focused. When the tracking servo following circuit 58 is activated, a laser beam spot automatically follows up an eccentric signal track of the optical recording medium 19. The focus servo following circuit 57 and the tracking servo following circuit 58 are provided with an automatic gain control function for automatically adjusting a focus gain and a tracking gain, respectively. The laser control circuit 59 is a circuit for generating the laser driving signal supplied from the laser driving circuit 55, and the circuit generates an a proper laser driving signal based on recording condition setting information that is recorded in the optical recording medium 19.

It is not essential that the focus servo following circuit 57, the tracking servo following circuit 58, and the laser control circuit 59 are circuits incorporated in the controller 54, and the circuits may be components separate from the controller 54. Further, it is not essential that the circuits are physical circuits, and they may be programs executed in the controller 54.

The invention is not limited to the above-described embodiment and may be modified in various ways.

For example, the separation preventing sections 11 described in the embodiment and modifications may be used with an objective lens 9 formed of either plastic or glass material.

The separation preventing sections 11 described in the embodiment and first through fifth modifications may be formed with a satin-like surface. In this case, a high interfacial energy is generated at the contact surface between the resin from which the lens protecting sections 27 are formed and the separation preventing sections 11, which makes it easier to maintain the lens protecting sections 27 in a predetermined shape.

Two separation preventing sections 11 are formed on the surface of the lens peripheral section 23 of the objective lens 9 such that they are substantially symmetric about the optical axis of the lens section 21 except in the first and the seventh modifications in which an annular separation preventing section 11 is formed. However, this is not limiting the invention. For example, the same advantage as that in the above-described embodiment can be achieved by forming one or three or more separation preventing sections 11 on the surface of the lens peripheral section 23.

1. An objective lens comprising:
a lens section for converging light emitted by a light source to irradiate a recording medium with the convergent light;
a lens peripheral section formed around the lens section integrally with the lens section and securing a lens protecting section which protects the lens section at the time of a collision with the recording medium; and
a separation preventing section formed in a region of the lens peripheral section where the lens protecting section is secured and preventing the lens protecting section from being separated from the lens peripheral section at the time of the collision.

2. An objective lens according to claim 1, wherein a surface of the separation preventing section is formed with roughness higher than that of a surface of the lens section.

3. An objective lens according to claim 1, wherein the separation preventing section is formed like a groove.

4. An objective lens according to claim 1, wherein the separation preventing section is formed like a protrusion.

5. An objective lens according to claim 1, wherein the separation preventing section is formed in two or more locations.

6. An objective lens according to claim 1, wherein the separation preventing section is formed like a ring extending in the circumferential direction of the lens peripheral section when viewed in the direction of the optical axis of the lens section.

7. An objective lens according to claim 1, wherein the lens protecting section is formed of an elastic material having hardness lower than that of the recording medium.

8. An objective lens according to claim 1, wherein the lens protecting section includes a resin having adhesive properties formed on the separation preventing section.

9. An objective lens according to claim 1, wherein the lens section and the lens peripheral section are formed of a plastic material.

10. An objective lens according to claim 1, wherein the lens section and the lens peripheral section are formed of a glass material.

11. An actuator comprising an objective lens according to claim 1.

12. An optical head comprising an actuator according to claim 11.

13. An optical recording/reproducing apparatus comprising an optical head according to claim 12.
